(19) United States
(12) Patent Application Publication
(10) Pub. No.: US 2022/0009555 A1
(43) Pub. Date: Jan. 13, 2022

(54) ILLUMINATABLE OUTER BODY PANEL FOR A VEHICLE AND OUTER BODY PANEL ILLUMINATION METHOD

(71) Applicant: Ford Global Technologies, LLC, Dearborn, MI (US)

(72) Inventors: Stuart C. Salter, White Lake, MI (US); Amy Lynn Marentic, Plymouth, MI (US); Paul Kenneth Dellock, Northville, MI (US); David Brian Glickman, Southfield, MI (US); Annette Lynn Huebner, Highland, MI (US)

(21) Appl. No.: 16/923,145

(22) Filed: Jul. 8, 2020

(51) Int. Cl. B62D 25/02; F21K 9/64; B62D 25/24; B60Q 1/32

(52) U.S. Cl. CPC B62D 25/02; F21K 9/64; F21Y 2115/10; B60Q 1/323; B62D 25/24

(57) ABSTRACT

A vehicle assembly includes, among other things, a replaceable outer body panel having an illuminatable portion, and at least one step within the replaceable outer body panel. The at least one step provides a step platform. A vehicle illumination method includes emitting light from a phosphor material of a replaceable outer body panel, and providing at least one step platform within the replaceable outer body panel.

### TECHNICAL FIELD

This disclosure relates to replaceable outer body panels of a vehicle and, more particularly, replaceable outer body panels that can emit light.

### BACKGROUND

Vehicles can include outer body panels. Some vehicles include replaceable outer body panels that can be removed by a user for reasons other than damage or repair. Users may periodically reconfigure their vehicle by switching a first replaceable outer body panel with a different, second replaceable outer body panel. The reconfiguring could be for functional reasons, aesthetic reasons, or both. In particular, a user may switch the outer body panels on a vehicle to give that vehicle a more rugged appearance, or to equip the vehicle with outer body panels more suitable to off-roading.

### SUMMARY

A vehicle assembly according to an exemplary aspect of the present disclosure includes, among other things, a replaceable outer body panel having an illuminatable portion, and at least one step within the replaceable outer body panel. The at least one step provides a step platform.

In another example of the foregoing vehicle assembly, the replaceable outer body panel includes a polymer-based material and a phosphor material. The illuminatable portion is provided by the phosphor material.

In another example of any of the foregoing vehicle assemblies, the phosphor material includes a long persistent phosphor having a persistence time that is greater than two hours.

In another example of any of the foregoing vehicles assemblies, the phosphor material further includes a low persistent phosphor having a persistence time that is less than two seconds.

Another example of any of the foregoing vehicles assemblies includes a lighting device that can illuminate to charge the phosphor material.

In another example of any of the foregoing vehicle assemblies, the lighting device is an ultraviolet light emitting diode.

In another example of any of the foregoing vehicles assemblies, the illuminatable portion is provided by a luminescent paint.

In another example of any of the foregoing vehicles assemblies, the at least one step comprises a first step having a step platform that is aft a wheel well area of the replaceable outer body panel, and a second step that is vertically above the wheel well area of the replaceable outer body panel.

In another example of any of the foregoing vehicles assemblies, a material composition of the replaceable outer body panel includes a thermoplastic polyolefin material and a phosphor material.

Another example of any of the foregoing vehicles assemblies includes a tool pocket of the replaceable outer body panel.

Another example of any of the foregoing vehicles assemblies includes a composite, metal alloy, or metallic reinforcement that is vertically beneath the step platform on an inboard side of the replaceable outer body panel.

In another example of any of the foregoing vehicles assemblies, the replaceable outer body panel is a front fender.

In another example of any of the foregoing vehicles assemblies, the illuminatable portion is at least partially disposed within the step platform.

In another example of any of the foregoing vehicles assemblies, the step platform is oriented along a substantially horizontally extending plane.

A vehicle illumination method according to another exemplary aspect of the present disclosure includes emitting light from a phosphor material of a replaceable outer body panel, and providing at least one step platform within the replaceable outer body panel.

Another example of the foregoing method includes activating a lighting device to charge the phosphor material.

Another example of any of the foregoing methods includes emitting ultraviolet light from the lighting device to charge the phosphor material.

In another example of any of the foregoing methods, a material composition of the replaceable outer body panel includes a thermoplastic polyolefin material and the phosphor material.

In another example of any of the foregoing methods, the phosphor material includes a long persistent phosphor having a persistence time greater than two hours, and a low persistent phosphor having a persistence time less than two seconds.

In another example of any of the foregoing methods, the at least one step platform comprises a first step platform that is aft a wheel well area of the replaceable outer body panel, and a second step platform that is vertically above the wheel well area.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a front perspective view of a motor vehicle.

FIG. 2 illustrates a close-up perspective view of a replaceable outer body panel on the vehicle of FIG. 1.

FIG. 3 illustrates the view of FIG. 2 after the replaceable outer body panel of FIG. 2 has been removed and replaced with another replaceable outer body panel.

FIG. 4 illustrates a side view of the replaceable outer body panel of FIG. 3.

FIG. 5 illustrates a perspective view of the replaceable outer body panel of FIG. 3.

### DETAILED DESCRIPTION

This disclosure relates generally to replaceable outer body panels for a vehicle. The replaceable outer body panels can include an illuminatable portion and at least one step.

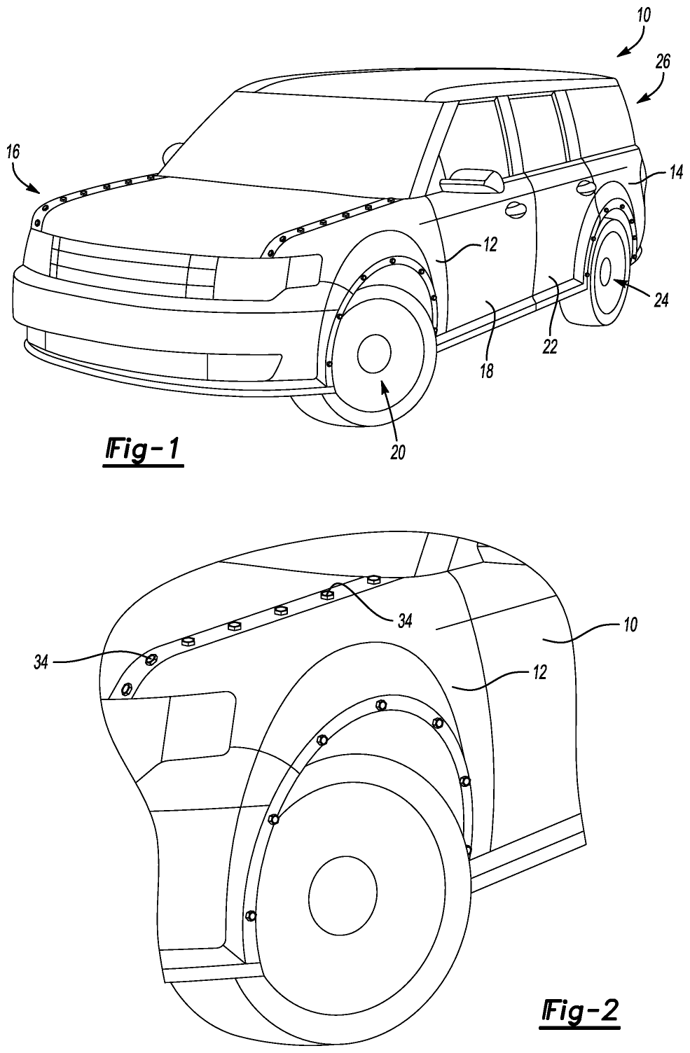

FIG. 1 shows a front perspective view of a motor vehicle 10. As shown, the vehicle 10 is a sport utility (SUV). While an SUV is pictured, this disclosure is applicable to other types of vehicles, such as vans and trucks (including pickup trucks).

The vehicle 10 includes a plurality of replaceable outer body panels 12, 14. The replaceable outer body panel 12 is a front driver side fender of the vehicle 10, and is arranged between a front end 16 of the vehicle and a driver side front door 18 of the vehicle 10. The replaceable outer body panel 12 includes a wheel well area 20 that receives a front wheel of the vehicle 10.

The replaceable outer body panel 14 is a rear driver side quarter panel of the vehicle 10, and is arranged between a rear driver side door 22 of the vehicle 10 and an aft end 26 of the vehicle 10. The replaceable outer body panel 14 includes a wheel well area 24 that receives a rear wheel of the vehicle 10.

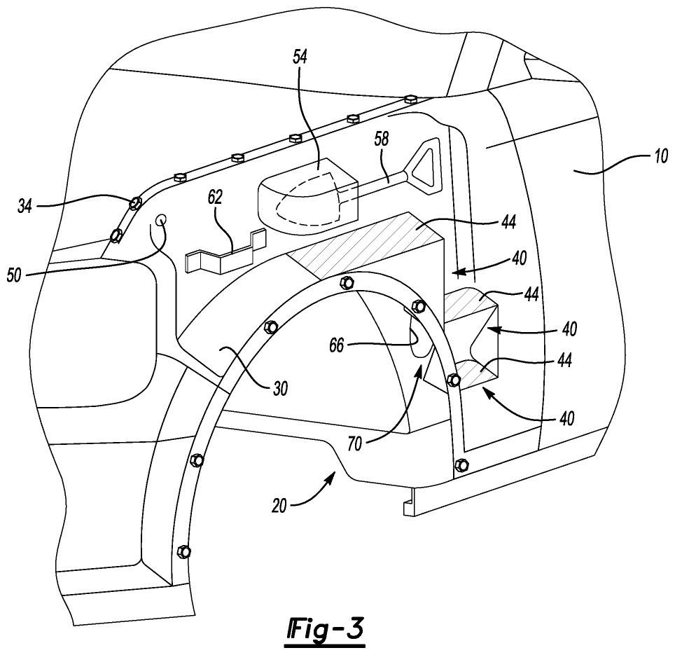

In this disclosure, at least the replaceable outer body panel 12 is configured to be selectively attached and removed (i.e., detached) from a body of the vehicle 10 by a user. In particular, the replaceable outer body panel 12 is configured to be selectively attached and removed from a frame of the vehicle 10 by the user for reasons other than damage or repair. The replaceable outer body panel 12 can thus be considered a removable or modular body panel. Because the replaceable outer body panel 12 is removable, the user can replace the outer body 12 for aesthetic reasons or for other reasons. In the exemplary embodiment, the modularity of the replaceable outer body panel 12 permits the user to switch the replaceable outer body panel 12 shown in FIGS. 1 and 2 with a different body panel, such as the replaceable outer body panel 30 of FIGS. 3-5.

In the exemplary embodiment, a plurality of threaded mechanical fasteners 34 attach the replaceable outer body panel 12 to the frame of the vehicle 10. The mechanical fasteners can be bolts, for example. To remove the replaceable outer body panel 12 from the vehicle, the user first removes the fasteners 34. The user can then move the replaceable outer body panel 12 away from the frame of the vehicle 10. Next, the user moves the replaceable outer body panel 30 into the installed position of FIG. 3, and attaches the replaceable outer body panel 30 to the frame of the vehicle with the fasteners 34.

In the exemplary embodiment, the replaceable outer body panel 30 is more robust than the replaceable outer body panel 12. The replaceable outer body panel 30 can be an aftermarket part or purchased as an accessory through an original equipment manufacturer (OEM). The optional use of the replaceable outer body panel 30 gives the user an option to equip the vehicle 10 with an outer body panel well-suited for off-roading or other pursuits.

The replaceable outer body panel 30, in the exemplary embodiment, includes an illuminatable portion and at least one step 40 providing a step platform 44.

The replaceable outer body panel 30 can be molded primarily from a relatively flexible material, such as thermoplastic polyolefin (TPO). The flexible material can be mixed with a phosphor material. When charged, the phosphor material of the replaceable outer body panel 30 emits light. The phosphor material can be disposed throughout the replaceable outer body panel 30 such that light is emitted from substantially all visible areas of the replaceable outer body panel 30 when the phosphor material is charged. The phosphor material can be charged passively by sunlight, or charged from a light source.

In another exemplary embodiment, the replaceable outer body panel 30 comprises a glass-filled polypropylene material mixed with the phosphor material. In such an example, the illuminatable portion of the replaceable outer body panel 30 is again provided by the phosphor material.

In exemplary embodiment, the replaceable outer body panel 30 includes three steps 40 each providing a step platform 44. The step platforms 44 are each disposed along a respective horizontal plane. Horizontal and vertical, for purposes of this disclosure are with reference to ground and the general orientation of the vehicle 10 during ordinary operation.

The user can place their feet on one or more of the step platforms 44. The user can then elevate themselves by stepping up on one or more of the step platforms 44. The replaceable outer body panel 30 supports the user stepping on the step platforms 44. The user can step on the step platforms 44 to help the user access, for example, cargo and other items stored on an upper area of the vehicle 10. The user can instead or additionally step on the one or more of the step platforms 44 to elevate themselves so that they can more easily observe a sporting event, for example.

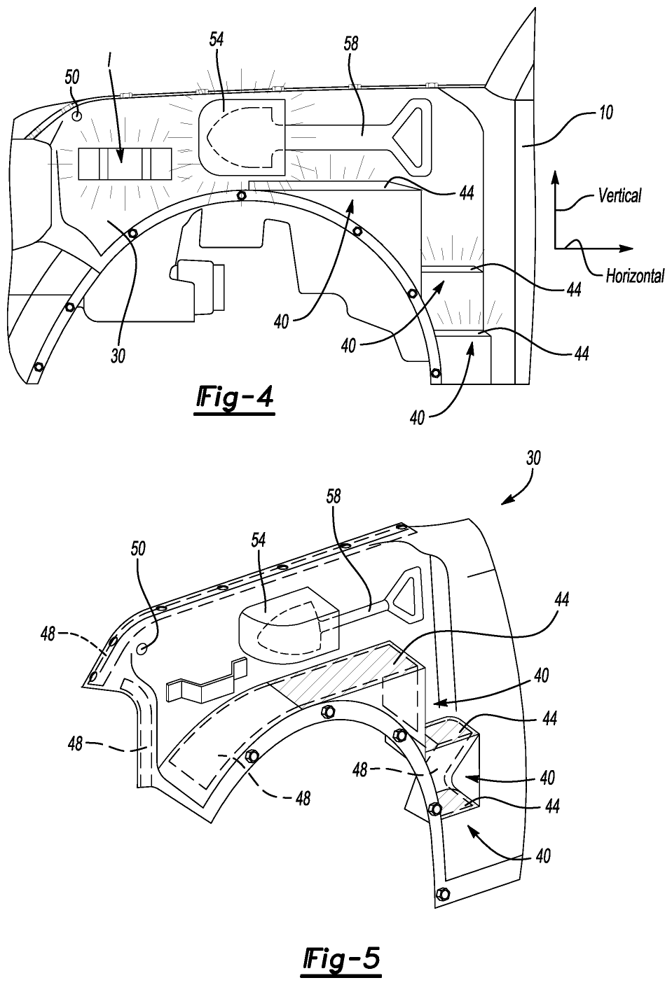

The replaceable outer body panel 30 can, in some examples, include the illuminatable portions in certain areas of the replaceable outer body panel 30 rather than throughout the replaceable outer body panel 30. For example, FIG. 4 shows an example where the step platforms 44 of the replaceable outer body panel 30 are illuminated, but not other areas of the steps 40. This can help the step platforms 44 visually stand out and can provide a user with a visual indication of where the step platforms 44 are located, especially in low light conditions.

To provide step platforms 44 that illuminate while other of the portions of the steps 40 do not illuminate, the replaceable outer body panel 30 could be molded using a two-stage molding process. The steps 40, other than the step platforms 44, could be formed in a first stage from a material composition that lacks a phosphor material. The step platforms 44 are then formed in a second stage from a material composition that includes a phosphor material. In other examples, the replaceable outer body panel 30 is blow molded, compression molded, or 3D printed.

The at least one step 40 includes, in this exemplary embodiment, two steps that are aft the wheel well area 20 of the replaceable outer body panel 30. The at least one step 40 further includes a step having its step platform 44 directly vertically above the wheel well area 20.

In this example, reinforcement members 48 (FIG. 5) are disposed along an inboard side of the replaceable outer body panel 30. The reinforcement members 48 can be a composite, metal alloy, or a metallic reinforcement material. The reinforcement members 48 can help to strengthen areas of the replaceable outer body panel 30. For example, the reinforcement members 48 can help to strengthen areas of the step platforms 44 to facilitate supporting the user when the user steps on the step platforms 44. Some of the reinforcement members 48 can be directly vertically beneath the step platforms 44 on an inboard side of the replaceable outer body panel 30.

The phosphor material of the exemplary body panel 30 can include a long persistent phosphor having a persistence time greater than two hours. A light source, such as sunlight, can charge the long persistent phosphor. After being fully charged, the long persistent phosphor can glow and emit light from 12 to 24 hours after the light source has been removed. In an example, a material composition of the replaceable outer body panel 30 includes from 3 to 30 percent long persistent phosphor. The long persistent phosphor can emit amber colored light, for example.

In this example, the light source includes at least one lighting device 50 attached to the replaceable outer body panel 30 or integrated into the replaceable outer body panel 30. When the user connects the replaceable outer body panel 30 to the frame of the vehicle 10, the user can connect a jumper harness associated with the replaceable outer body panel 30 to electrically couple the lighting device 50 to a power source on the vehicle, such as a 12-Volt accessory battery. For drawing clarity, one lighting device 50 is shown. More than one lighting device could be used, however.

The lighting device 50 can be a light emitting diode (LED) that emits light. In the exemplary embodiment, the lighting device 50 includes at least one ultraviolet (UV) LED that emits UV light with a 380-400 nanometer wavelength. In a specific example, the UV LED emits UV light with a 385-390 nanometer wavelength.

The UV LED can be contained within a sealed housing of the replaceable outer body panel 30. The UV LED can be recessed relative to surrounding areas of the replaceable outer body panel 30, which can help to conceal the UV LED.

When powered, the UV LED can emit UV light that charges the phosphor material of the replaceable outer body panel 30. Because the light emitted from the UV LED is UV light, individuals would not observe visible light being emitted from the UV LED or notice when the UV LED is turned on or turned off.

In an exemplary embodiment, an illuminatable portion of the replaceable outer body panel 30 can include short persistent phosphors instead of, or in addition to, long persistent phosphors. A material composition of the replaceable outer body panel 30 can include, for example, from 5 to 50 percent short persistent phosphor.

The lighting device 50, when activated, can charge the short persistent phosphor. After the lighting device 50 is deactivated, the short persistent phosphor stops emitting light very quickly, say less than two seconds.

Incorporating the short persistent phosphor into the replaceable outer body panel 30 can facilitate use of the replaceable outer body panel 30 as an auxiliary turn signal indicator. When, for example, the user is operating the vehicle and has activated the left turn signal, the lighting device 50 can be activated, which charges the short persistent phosphor. The short persistent phosphor then emits light. The light emitted from the short persistent phosphor can provide a visual indication of the turning direction of the vehicle 10. Light emitted from the short persistent phosphor of the replaceable outer body panel 30 can be in addition to light from headlight assemblies, or turn signal lamps of the vehicle.

Again, light emitted from the short persistent phosphor rapidly decreases in intensity very quickly after the lighting device 50 is no longer activated. Thus, the light emitted from the replaceable outer body panel 30 indicating that the vehicle 10 is turning stops very soon after the turning of the vehicle 10 and after the lighting device 50 is no longer activated. The net effect of the short persistent phosphor and the selectively activated lighting device 50 can be a pulsation of light emitted from the replaceable outer body panel 30 when the vehicle 10 is turning left and has its left turn signal activated along with the lighting device 50.

The short persistent phosphor of the replaceable outer body panel 30 can emit light in a first color, while the long persistent phosphor of the replaceable outer body panel 30 can emit light in a different, second color. If the first color is amber and the second color is green, the outer body panel 30 could flash with an amber color when the turn signal is activated, and emit green light before, during, and after turning.

The replaceable outer body panel 30 further includes, in the exemplary embodiment, a tool pocket 54 that includes an open area configured to receive a tool, here a shovel 58. Providing the tool pocket 54 enables the user to store a tool, which may be dirty, outside of a passenger compartment of the vehicle 10.

The tool pocket 54 can be part of the illuminatable portion of the replaceable outer body panel 30 that can be illuminated while surrounding areas of the replaceable outer body panel 30 are not illuminated. This can provide a visual indication of the location of the tool pocket 54 to the user, especially in low light conditions. The tool pocket 54 can be molded with the remaining portions of the replaceable outer body panel 30, or formed separately from the replaceable outer body panel 30.

In the exemplary embodiment, the replaceable outer body panel 30 further includes a grab handle 62. The grab handle 62 can be utilized by the user for assistance when climbing on the replaceable outer body panel 30, and particularly the step platforms 44 of the replaceable outer body panel 30.

The grab handle 62 can further provide a tie down location for cargo on the vehicle 10. The grab handle 62 can provide a portion of the illuminatable portion of the replaceable outer body panel 30, while the areas of the replaceable outer body panel 30 surrounding the grab handle 62 are not illuminated. This can provide a visual indication to the user of the location of the grab handle 62, particularly in low light conditions. The grab handle 62 can be molded with the remaining portions of the replaceable outer body panel 30, or formed separately from the replaceable outer body panel 30.

The tool pocket 54, the grab handle 62, or both could be mechanically fastened directly to the vehicle frame using mechanical fasteners, which can help to avoid the need for additional reinforcement structures in these areas.

In addition to the step platforms 44, the tool pocket 54, and the grab handle 62, the replaceable outer body panel 30 could, in other examples, include flag holders, bottle openers, saddle bags for tools and/or water bottles and gas cans. The replaceable outer body panel 30 could incorporate clips utilized to secure tools or lights. The replaceable outer body panel 30 could include a mount for an activity camera. The replaceable outer body panel 30 could include perimeter lights that illuminate the ground and areas around the vehicle.

The exemplary replaceable outer body panel 30 is spaced away from a speaker mount location 66 on a cowl of the vehicle. This provides a hollow cavity area 70 between the speaker mount location 66 and the inboard surface of the replaceable outer body panel 30. The hollow cavity area 70 can help to ensure that the replaceable outer body panel 30 does not interfere with sound emanating from the speaker held in the speaker mount location 66. In particular, the step platform 44 is bumped outboard away from the speaker mount location 66 to provide clearance to a speaker held in the speaker mount location 66.

In the exemplary embodiments, the illuminatable portions of the replaceable outer body panel 30 are molded together with other portions of the replaceable outer body panel 30. That is not required, however.

For example, the replaceable outer body panel 30 can instead or additionally include illuminatable portions provided by areas that are painted with a luminescent paint. In such an example, the luminescent paint provides the illuminatable portion of the replaceable outer body panel 30. As an example, the step platforms 44 and the remaining portions of the steps 40 could be molded together using materials that do not emit light. A luminescent paint can then be added onto the step platforms 44, but not the remaining portions of the steps 40.

The illuminatable portions can be painted or pad printed areas of the replaceable outer body panel 30. The paint or ink utilized in the painting or pad printing process can include a long persistent phosphor.

In addition to the step platforms 44, the tool pocket 54 and the grab handle 62 can also be painted with a luminescent paint. Other areas of the replaceable outer body panel 30 may not include any luminescent paint. In such an example, the luminescent paint on the step platforms 44, the tool pocket 54, and the grab handle 62 emits light when charged as shown in FIG. 4. The other areas of the replaceable outer body panel 30 are not painted with luminescent paint and do not emit light. Thus, the step platforms 44, the tool pocket 54, and the grab handle 62 stand out from the other areas of the replaceable outer body panel 30.

In yet another exemplary embodiment, the replaceable outer body panel 30 is molded from a polymer based material mixed with a short persistent phosphor. The replaceable outer body panel 30 can be from 5 to 60% short persistent phosphor, for example. The short persistent phosphor can emit light when charged by, for example, the light device 50 as previously described. The step platforms 44, the tool pocket 54, and the grab handle 62 could then be painted with a paint having a long persistent phosphor. In such an embodiment, the step platforms 44, the tool pocket 54, and the grab handle 62 can emit light for relatively long amount of time after being charged. The remaining portions of the replaceable outer body panel 30, which are molded with the material including the short persistent phosphor, emit light for a short period of time after being charged by the lighting device 50. This enables the replaceable outer body panel 30 to be used as an auxiliary turn signal indicator via the short persistent phosphor, while still providing an indication to the user of a location of the step platforms 44, the tool pocket 54, and the grab handle 62 in low light conditions via the long persistent phosphor.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

1. A vehicle assembly, comprising:
a replaceable outer body panel having an illuminatable portion; and
at least one step within the replaceable outer body panel, the at least one step providing a step platform; and
at least one lighting device of the replaceable outer body panel, the at least one lighting device disposed a distance away from all portions of the at least one step.

2. The vehicle assembly of claim 1, wherein the replaceable outer body panel comprises a polymer-based material and a phosphor material, the illuminatable portion provided by the phosphor material.

3. The vehicle assembly of claim 2, wherein the phosphor material comprises a long persistent phosphor having a persistence time that is greater than two hours.

4. The vehicle assembly of claim 3, wherein the phosphor material further comprises a low persistent phosphor having a persistence time that is less than two seconds.

5. The vehicle assembly of claim 2, wherein the at least one lighting device is configured to illuminate to charge the phosphor material.

6. (canceled)

7. The vehicle assembly of claim 1, wherein the illuminatable portion is provided by a luminescent paint.

8. The vehicle assembly of claim 1, wherein the at least one step comprises a first step having a step platform that is aft a wheel well area of the replaceable outer body panel, and a second step having a step platform that is vertically above the wheel well area.

9. (canceled)

10. The vehicle assembly of claim 1, further comprising a tool pocket within the replaceable outer body panel, the tool pocket part of the illuminatable portion.

11. The vehicle assembly of claim 1, further comprising a composite, metal alloy, or metallic reinforcement that is vertically beneath the step platform on an inboard side of the replaceable outer body panel.

12. The vehicle assembly of claim 1, wherein the replaceable outer body panel is a front fender.

13. The vehicle assembly of claim 1, wherein the illuminatable portion is at least partially disposed within the step platform.

14. The vehicle assembly of claim 1, wherein the step platform is oriented along a substantially horizontally extending plane.

15. A vehicle illumination method comprising:
emitting light from a phosphor material of a replaceable outer body panel; and
providing at least one step platform within the replaceable outer body panel, the at least one step platform part of at least one step,
wherein a material composition of the at least one step platform includes the phosphor material, wherein portions of the at least one step other than at least one step platform lack a phosphor material.

16. The vehicle illumination method of claim 15, further comprising activating a lighting device to charge the phosphor material, the lighting device disposed within an area of the replaceable outer body panel that is outside the at least one step.

17. The vehicle illumination method of claim 16, further comprising emitting ultraviolet light from the lighting device to charge the phosphor material.

18. The vehicle illumination method of claim 15, wherein a material composition of the replaceable outer body panel includes a thermoplastic polyolefin material and the phosphor material.

19. The vehicle illumination method of claim 15, wherein the phosphor material comprises a long persistent phosphor having a persistence time greater than two hours, and a low persistent phosphor having a persistence time less than two seconds.

20. The vehicle illumination method of claim 15, wherein the at least one step platform comprises a first step platform that is aft a wheel well area of the replaceable outer body panel, and a second step platform that is vertically above the wheel well area.

21. The vehicle assembly of claim 1, further comprising a tool pocket within the replaceable outer body panel, the tool pocket part of the illuminatable portion,
wherein the at least one step comprises a first step having a step platform that is aft a wheel well area of the replaceable outer body panel, and a second step having a step platform that is vertically above the wheel well area,
wherein the tool pocket is vertically above the step platform of the second step.

22. The vehicle assembly of claim 1, wherein a material composition of the step platform includes a phosphor material, wherein portions of the step other than the step platform lack a phosphor material.
